(19) United States
(12) Patent Application Publication
(10) Pub. No.: US 2013/0151526 A1
(43) Pub. Date: Jun. 13, 2013

(54) SNS TRAP COLLECTION SYSTEM AND URL COLLECTION METHOD BY THE SAME

(71) Applicant: KOREA INTERNET & SECURITY AGENCY, Seoul (KR)

(72) Inventors: Hyun Cheol Jeong, Seoul (KR); Seung Goo Ji, Seoul (KR); Tai Jin Lee, Seoul (KR); Jong II Jeong, Seoul (KR); Hong Koo Kang, Seoul (KR); Byung Ik Kim, Seoul (KR)

(73) Assignee: KOREA INTERNET & SECURITY AGENCY, Seoul (KR)

(21) Appl. No.: 13/674,663

(22) Filed: Nov. 12, 2012

(30) Foreign Application Priority Data
Dec. 9, 2011 (KR) 10-2011-0132134

(51) Int. Cl. G06F 17/30

(52) U.S. Cl. 707/737; 707/E17.046

(57) ABSTRACT

A social networking service (SNS) trap collection system capable of accurately and effectively extracting and collecting information including a malicious code among information exchanged in an SNS, and a uniform resource location (URL) collection method by the same. URL information for a malicious code included in post (a bulletin script, a message, a note, or the like) exchanged is effectively collected by using an account IDD and a password of account information and utilized for detecting a malicious code in the SNS, thus significantly reducing damage to users due to infection of a malicious code.

### BACKGROUND OF THE INVENTION

1. Field of the Invention

The present invention relates to a social networking service (SNS) trap collection system and a uniform resource locator (URL) collection method by the same and, more particularly, to an SNS trap collection system capable of accurately and effectively extracting and collecting information including a malicious code among information exchanged in an SNS, and a URL collection method by the same.

2. Description of the Related Art

Recently, many people use a social networking service (SNS) to share interests or activities with close acquaintances. In particular, mobile devices such as smart phones, tablet PCs, and the like, have become rapidly prevalent to allow users to bring their word or readily hear of acquaintances, irrespective of places. Service types of SNS include foreign-based SNS such as Twitter, Facebook, and the like, and domestic SNS such as Cyworld, me2day, and the like.

However, SNS allowing a user to exchange information with acquaintances in real time also has disadvantages as well as advantages as mentioned above. The biggest problem is inspection of a malicious code due to a connection to a malicious Website. Other problems such as a leakage of personal information, dissemination of false information, and impersonation of a celebrity, and the like, also exist.

Among them, existing malicious code dissemination usually features dissemination of malicious codes through hacking of a Web page. Dissemination of malicious codes target many and unspecified users. An attempter of a malicious code should hack a normal Web page and insert a malicious code flow URL. Or, a process of inducing a false Web page similar to an actual Web page is required.

Thus, the existing malicious code dissemination method requires multiple preparation processes, and a failure of one of the processes results in a failure of dissemination of a malicious code.

Currently, in case of disseminating a malicious code through an SNS, since a user who creates an SNS post (or an SNS notice) and a visitor are trusted, a malicious code can be more definitely disseminated. Also, in order to disseminate a malicious code, inducement of users through website hacking is not necessary, so an effective malicious code dissemination path is generated.

Thus, in addition to the features, a malicious code is disseminated within a shorter time than in the past, by using the advantages of the SNS exchanging information in real time. Thus, a more stable Internet environment is required to be established by checking dissemination of a malicious code in the SNS which sees an increasing number of users, but a method that may be able to quickly cope with it has yet to be presented.

### SUMMARY OF THE INVENTION

An aspect of the present invention provides social networking service (SNS) trap collection system and a URL collection method by the same capable of locating a URL for a malicious code disseminated from SNS post such as a bulletin board message (i.e., a bulletin script or an online article), a message, or a note, based on real-time search word information provided from a search site and utilizing the same.

Features of the present invention to achieve the object of the present invention and perform characteristic functions of the present invention as mentioned above are as follows.

According to an aspect of the present invention, there is provided a social networking service (SNS) trap collection system including: an SNS account collecting module configured to periodically check subscribed or registered account information of each SNS site, and XML-parse the checked account information to collect the same; an account calling module configured to call a certain account which has logged in to the SNS site based on account ID/password information as the result of the XML parsing; a post collecting module configured to collect post of the called account by using a post check open API; a URL collecting module configured to store text content of each collected post and extract and collect URL information included in the text content; and a URL storage module configured to store the collected URL information in the form of an XML document.

The SNS trap collection system may further include: an original URL collecting module configured to access an original site which has generated a shortened URL to obtain original URL information from the original site, when the URL information is a shortened URL.

The URL storage module may store the URL information and original URL information in the form of a BOARD tag or MSG tag in the XML document.

The post collecting module may collect the post through crawling.

The SNS trap collection system may further include: a URL management module configured to check whether or not the URL information and the original URL information are repeated based on the stored XML document, remove the repeated URL information and original URL information, and record a collecting time.

According to another aspect of the present invention, there is provided a social networking service (SNS) uniform resource locator (URL) collection method including: (a) periodically check subscribed account information of each SNS site to determine whether or not a check period of the account information has lapsed; (b) when the check period has not been lapsed according to the determination result, XML-parsing the checked account information and collecting the same; (c) calling a certain account which has logged in to the SNS site based on account ID/password information as the result of XML-parsing; (d) determining whether or not there is post initiated by the called account by using a post check open API; (e) when there is post according to the determination result, collecting the post; (f) storing text content of each collected post, and extracting and collecting URL information included in the text content; and (g) storing the collected URL information in the form of an XML document.

(b) may include: (h) when the check period has lapsed according to the determination result, comparing the number of accounts to be checked within the period and the number of already analyzed accounts and performing (c) when the number of analyzed accounts is greater.

The SNS URL collection method may further include: (i) when the URL information is a shortened URL, accessing an original site which has generated the shortened URL and obtaining original URL information from the original site.

The SNS URL collection method may further include: (j) checking whether or not the URL information and the original URL information are repeated based on the XML document, respectively, removing the repeated URL information and original URL information, and recording a collecting time.

In (f), the URL information and the original URL information may be stored in the form of a BOARD tag or an MSG tag in the XML document.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view illustrating an SNS trap collection system 100 according to a first embodiment of the present invention.

FIG. 2 is a view illustrating an XML format of URL information according to the first embodiment of the present invention.

FIGS. 3 to 5 are flow charts illustrating a URL collection method (S100) according to a second embodiment of the present invention.

FIG. 6 is a diagram illustrating a process of processing a shortened URL according to the second embodiment of the present invention.

### DETAILED DESCRIPTION OF THE PREFERRED EMBODIMENT

Hereinafter, embodiments will be described in detail with reference to the accompanying drawings such that they can be easily practiced by those skilled in the art to which the present invention pertains. However, the present invention may be implemented in various forms and not limited to the embodiments disclosed hereinafter. Also, similar reference numerals are used for the similar parts throughout the specification.

### First Embodiment

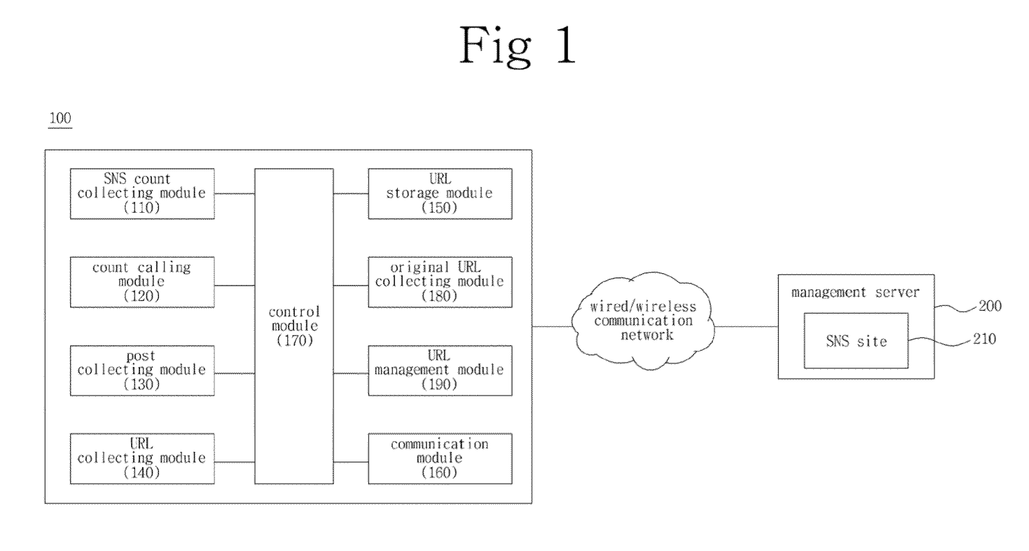

FIG. 1 is a view illustrating an SNS trap collection system 100 according to a first embodiment of the present invention.

Referring to FIG. 1, the SNS trap collection system 100 according to the first embodiment of the present invention is configured to include an SNS account collecting module 110, an account calling module 120, a post collecting module 130, a URL collecting module 140, a URL storage module 150, a communication module 160, and a control module 170.

First, the SNS account collecting module 110 serves to periodically check information regarding an account subscribed by each SNS site 210. To this end, the SNS account collecting module 110 may be associated with a management server 200 that manages an SNS site 210 to periodically access the management server 200 through permission of the management server 200 or through log-in to the management server 200, to thereby check information regarding a subscribed or registered account of each SNS site 210.

Here, preferably, the account information is collected through XML parsing. When XML parsing is performed by the SNS account collecting module 110, unnecessary factors such as an account address of a user, a resident registration number of a user, a phone number of a user, and the like, may be removed, and only essential account information such as an account ID, a password, the number of accounts, and the like, for achieving the object of the present invention can be collected. Here, one SNS site 210 and one management server 200 are illustrated for the description purpose, but the present invention is not limited thereto and a plurality of SNS sites and a plurality of management servers may be provided.

The account calling module 120 serves to call a certain account logged in to the SNS site 210 based on account ID and password information as results obtained from the XML parsing.

In general, post is posted on the SNS site 210 by the medium of an account ID and a password of a logged-in user, so the certain account may be called based on the user's account ID and password. In this case, calling may be generated according to results obtained by continuously monitoring the logged-in account ID (user), or may be generated in response to an alarm received based on the logged-in account from the management server 200 of the SNS site 210. Meanwhile, post as mentioned above generally refers to a function such as a bulletin script, a message, a note, or the like, in the form of being mainly posted in an SNS.

The post collecting module 130 serves to collect post posted by the account (user) called by the account calling module 120, from the SNS site 210. Here, in order to access the pointing posted on the SNS site 210, a post check open API as shown in Table 1 below is used.

The open API provided from the SNS site 210 is generally provided for the purpose of a developer, but in the present embodiment, the open API is used for the purpose of obtaining URL information (shortened URL information) present in the post as described hereinafter.

TABLE 1

| SNS | API |
|---|---|
| Twitter | http://twitter.com/statuses/user_timeline/account name.rss |
| Facebook | http://www.facebook.com/feeds/page.php?format=atom10&id= [symbol] ID |
| M2day | http://me2day.net/account name/rss_daily |
| | http://me2day.net/account name/friends/all.rss |

Example of Post Check Open API

In this manner, when the open API provided from the SNS site 210 is used, up to a position of post posted in the search site can be accessed, so the post collecting module 130 can easily obtain the post.

The URL collecting module 140 stores text content of each post collected by the post collecting module 130 and extract and collect URL information present in the text content.

For example, text content of post such as a bulletin script includes URL information indicating a source of information thereof recorded therein all the time. Similarly, post such as a message or a note includes URL information indicating a source of a spam mail disguised as a message of an SNS account manager or a friend recorded therein.

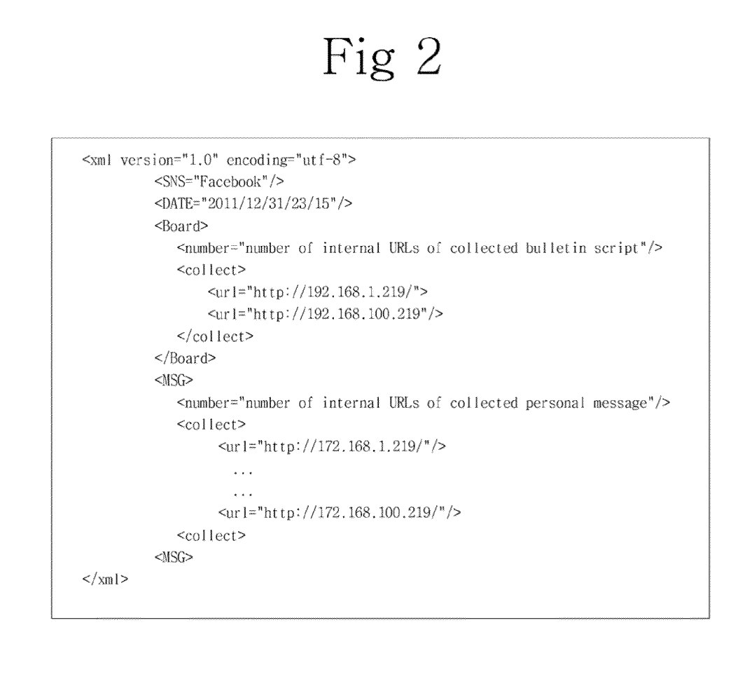

Thus, the URL collecting module 140 according to an embodiment of the present invention may directly extract and collect URL information included in the text content of the post of the logged-in account. Here, preferably, the URL information may be collected by crawling the post in the form of SML. Here, the URL information collected by the URL collecting module 140 may be in the form of BOARD tag or MSG tag in XML. The XML form of the URL information may be represented as shown in FIG. 2.

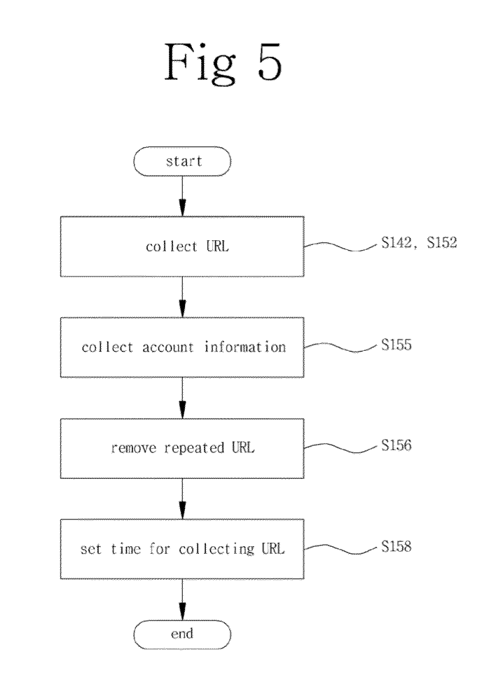

Also, the finally collected URL information may be changed into a URL list form through a crawling process. An example of the URL list form is illustrated in FIG. 5.

The URL information included in text of the post of the SNS or the post such as a message or a note is utilized for locating a malicious code in the SNS.

The URL storage module 150 serves to store the URL information collected by the URL collecting module 140, in the form of an XML document. In other words, the URL information collected by the URL collecting module 140 as described above may be changed into an XML document form, e.g., a URL list type XML document form, through a crawling process. An example of the XML document form is illustrated in FIG. 5.

The communication module 160 supports a communication interface between the SNS trap collection system 100 and the management server 200 providing the SNS site 210 to allow the SNS trap collection system 100 and the management server 200 to smoothly transmit and receive data therebetween.

Thus, as noted therethrough, the post information collected from the SNS site 210 and the URL information derived therefrom are substantially collected from the management server 200 that manage the SNS site 210.

The control module 170 according to an embodiment of the present invention controls a data flow among the SNS account collecting module 110, the account calling module 120, the post collecting module 130, the URL collecting module 140, the URL storage module 150, and the communication module 160, to thus allow the SNS account collecting module 110, the account calling module 120, the post collecting module 130, the URL collecting module 140, the URL storage module 150, and the communication module 160 to process unique data thereof, respectively.

In this manner, the SNS trap collection system through an SNS trap according to the first embodiment of the present invention advantageously utilized to detect a malicious code generated in the SNS by collecting post based on a logged-in account and collecting URL information of text content of the post. In comparison, the related art cannot provide such a mechanism of detecting URL information.

Meanwhile, SNS trap collection system through an SNS trap according to the first embodiment of the present invention may further include an original URL collecting module 180 and a URL management module 190. When URL information of the post is checked to be a shortened URL, the original URL collecting module 180 serves to access an original site which has generated the shortened URL, and obtain original URL information from the original site.

The obtained original URL information may be generated through a crawling process, like the foregoing URL collecting module 140. In this manner, even in the case of the shortened URL in the text content of the collected post, the original URL information may be collected effectively. The finally obtained original URL information is in line with the foregoing URL information.

Here, the shortened URL information collected by the original URL collecting module 180 may also be stored in the form of an XML document in the URL storage module 150, and preferably, it may be stored in the form of a BOARD tag or an MSG tag in the XML document.

Meanwhile the URL management module 190 serves to check whether or not the URL information and the original URL information are repeated based on the XML document information stored in the URL storage module 150, remove repeated URL information and original URL information, and record a collecting time.

To this end, the URL management module 190 may check whether or not the information is repeated and recognize the collecting time in association with the SNS account collecting module 110, the account calling module 120, the post collecting module 130, the URL collecting module 140, the URL storage module 150, the original URL collecting module 180, and the like.

For example, when the URL management module 190 is associated with the post collecting module 130, event occurs each time the post collecting module 130 collects corresponding post information, so the URL management module 190 may recognize a collecting time, and the URL management module 190 may determine whether or not the URL information and the original URL information are repeated by checking the post and the URL information (original URL information) stored in the URL storage module 150 and the original URL collecting module 180, respectively.

### Second Embodiment

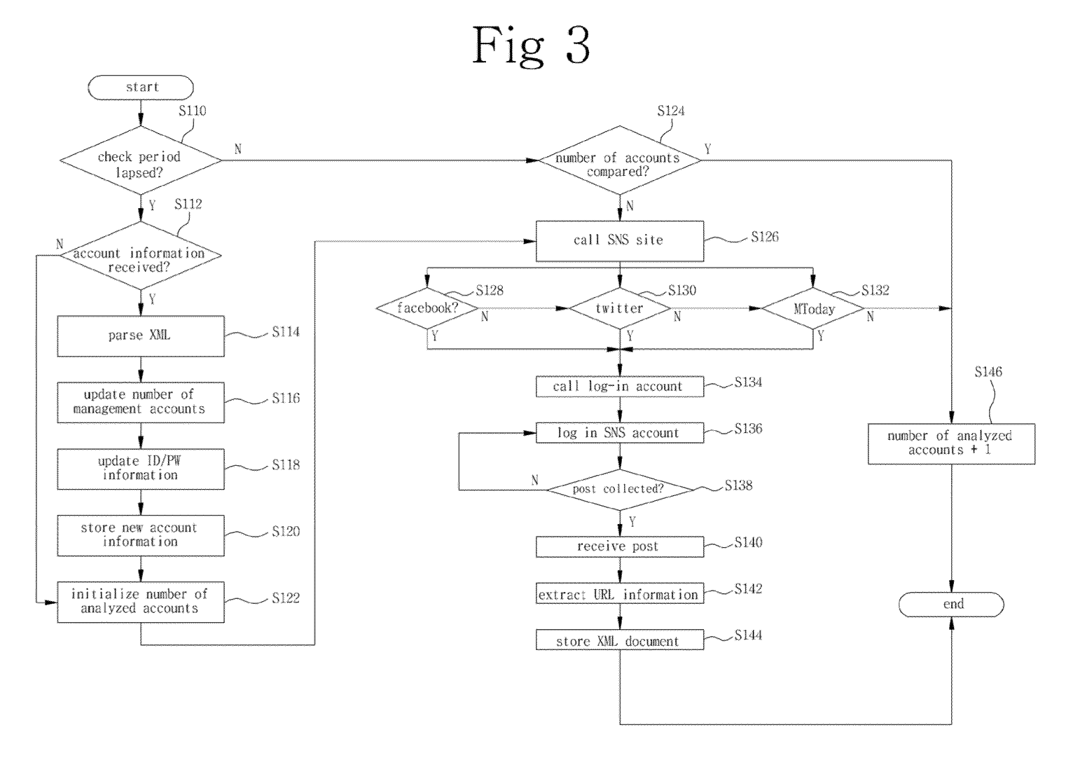

FIGS. 3 to 5 are flow charts illustrating a URL collection method (S100) according to a second embodiment of the present invention.

Referring to FIG. 3, the URL collection method S100 according to the second embodiment of the present invention includes steps S110 to S146 to collect a URL included in text of post such as a bulletin script, a message, a note, or the like, infected by a malicious code generated in the SNS site 210. The URL collection method S100 is based on the respective elements of the SNS trap collection system of FIG. 1 as mentioned above.

First, in step S110 subscribed or registered account information of each SNS site 210 is periodically checked to determine whether or not a check period of the account information has lapsed. When the account information is within the check period, step S112 is performed, or otherwise, step S124 is performed.

When it is recognized that the account information is within the check period in step S112, it is determined whether or not the account information has been received from the SNS site 210 (management server 200). Here, the account information refers to including information such as an account ID or a password, as well as personal information of a user who has newly subscribed or already registered and logged in.

When the account information has been normally received in step S112, the received account information is XML-parsed in step S114 When XML parsing is performed, only account information such as an account ID or password, excluding personal information, of a certain user who has logged in to the SNS site 210 may be extracted.

In step S116, the number of management account is updated whenever the XML-parsed account information is checked.

In step S118, it is determined whether or not the XML-parsed account ID and password have been already stored. When there is no XML-parsed account ID and password, the account ID and the password are stored for updating. When there are already stored account ID and password, they are deleted.

In step S120, in case of new account information (account ID/password), it is stored. Here, preferably, the account ID and the password are stored as a pair.

In step S122, existing analysis information (here, analysis information refers to a stored account to be checked) is initialized for new checking. The number of analyzed accounts is not initialized immediately after the SNS trap collection system 100 checks all the accounts. However, in case that checking of all the accounts within the check period is completed, when the number of analyzed accounts is initialized, the same account may be checked again. Step S122 may be performed although the account information in step S112 is not received.

In step S126, the SNS site 210 is called. Step S126 may also be performed by negating step S124.

Namely, when the check period has lapsed in step S110, the number of accounts to be visited and checked within a pre-set period and the number of analyzed accounts are compared in step S124. When the number of the analyzed accounts is smaller than the number of accounts to be visited and checked within the pre-set period according to the comparison result, step S126 is performed to call the SNS site 210. When the number of the analyzed accounts is greater than the number of accounts to be visited and checked within the pre-set period according to the comparison result, step S146 is performed to increase the number of analyzed accounts.

In steps S128, S130, and S132 which of SNS sites is called in step S126 is determined. For example, when the site is a Facebook SNS site, step S134 is immediately performed, or otherwise, it is checked whether or not the site is a Twitter SNS site, or otherwise, it is checked whether or not the site is an m2day SNS site.

After steps S128, S130, and S132 in which the certain SNS site is called is performed, step S134 is performed in case of a corresponding SNS site. In step S134, a certain account logged into the SNS site is called based on the account/password information as a result of XML parsing in step S114. Here, the call may be generated in response to a signal alarm, etc.) transmitted from the corresponding SNS site (management server) which has detected a logged-in accounter.

In step S136, SNS account log-in is performed in order to access the corresponding SNS site which has been called. Such SNS account log-in may be automatically performed.

In step S138, it is determined whether or not the account (or the user) logged in according to the calling in step S134 has posted post

In step S140, when it is determined there is post according to the determination result of FIG. 138, the post is received and stored, in this case, the post is received by using a post check open API.

in step S142, the post received in step S140 is crawled in an XML form to extract URL information from text content of the post. Here, the URL information extracted from the post may be original URL information by a shortened URL.

In step S144, the URL information (original URL information) extracted in step S142 is stored as an XML document. Here, the XML document may have an XML list form. The XML document (URL information) obtained through the foregoing process is utilized to detect a malicious code.

Meanwhile step S146 is performed when the fact that the post has been received is checked, or when the number of analyzed accounts is greater than the number of accounts to be visited and checked within the pre-set period according to comparison between the numbers of accounts in step S124. In step S146, the number of analyzed accounts is increased by including the account (the user number) which has initiated the post in the number of analyzed accounts. In this case, the number of analyzed accounts is increased by the number of accounts. In this manner, a newly subscribed or already registered account may be effectively managed.

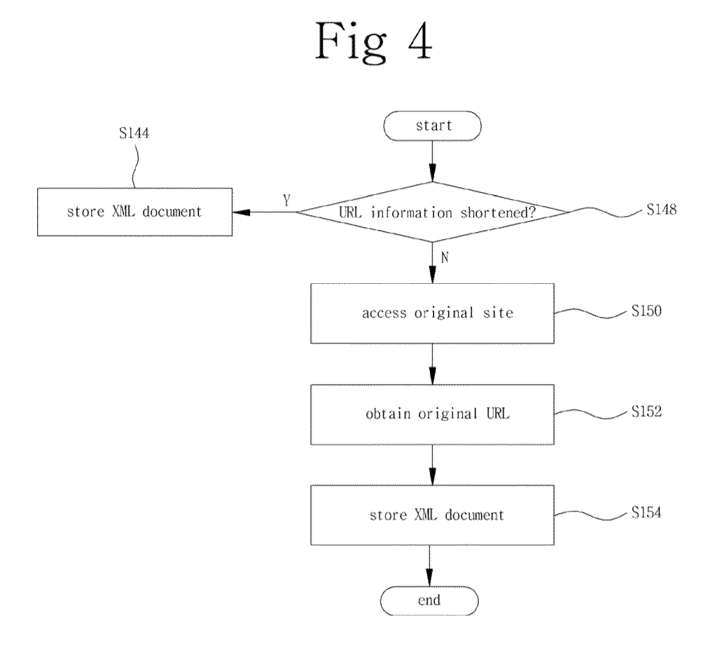

Next, referring to FIG. 4, the URL collection method S100 according to the second embodiment of the present invention includes steps S148 to S154 starting from determining whether or not the URL information existing in the text content of the post is a shortened URL based on the collected post to obtaining an original URL. The URL collection method S100 is based on the original URL collecting module 180 illustrated in FIG. 1 as described above, and incidentally based on the URL storage module 150, the URL collecting module 140, and the like.

First, in step S148, it is determined whether or not URL information existing in the text content of the post is a shortened URL based on the collected post. When the URL information is determined not to be a shortened URL but URL information, the URL information is stored as an XML document (S144).

In step S150, when it is determined that the URL information existing in the text content of the post is a shortened URL according to the determination result in step S148, an original site is accessed by using the shortened URL. Thereafter, in step S152, original URL information is obtained from the original site. In step S154, the obtained original URL information is stored as an XML document like the URL information.

Finally, referring to FIG. 5, the URL collection method according to the second embodiment of the present invention includes steps S142 to S158 to determine whether or not the URL information collected in steps S142 and S152 as described above is repeated one based on the original URL or set a collecting time with respect to a corresponding URL. The URL collection method S100 is based on the URL management module 190 in FIG. 1 as described above, but the present invention is not necessarily limited thereto. For example, the URL collection method S100 may be based on the URL storage module 150, the URL collecting module 140, the original URL collecting module 180, and the like.

First, in steps S142 and S152, there are URL information included in the text content of the post extracted from the collected post and the original URL information obtained in a follow-up process.

In step S155, when the URL information and the original URL information are collected, an account which has posted the post as a source can be known naturally, so corresponding account information is collected.

In step S156, it is determined whether or not the newly obtained account has been already registered, and when the account is a repeated account, a repeated URL is removed. In step S158, a URL, collecting time is set to fit the URL information and/or original URL information obtained in steps S142 and/or S152. By removing the repeated URL or setting the collecting time through the process the number of accounts can be easily managed and analyzed.

Example of Shortened URL

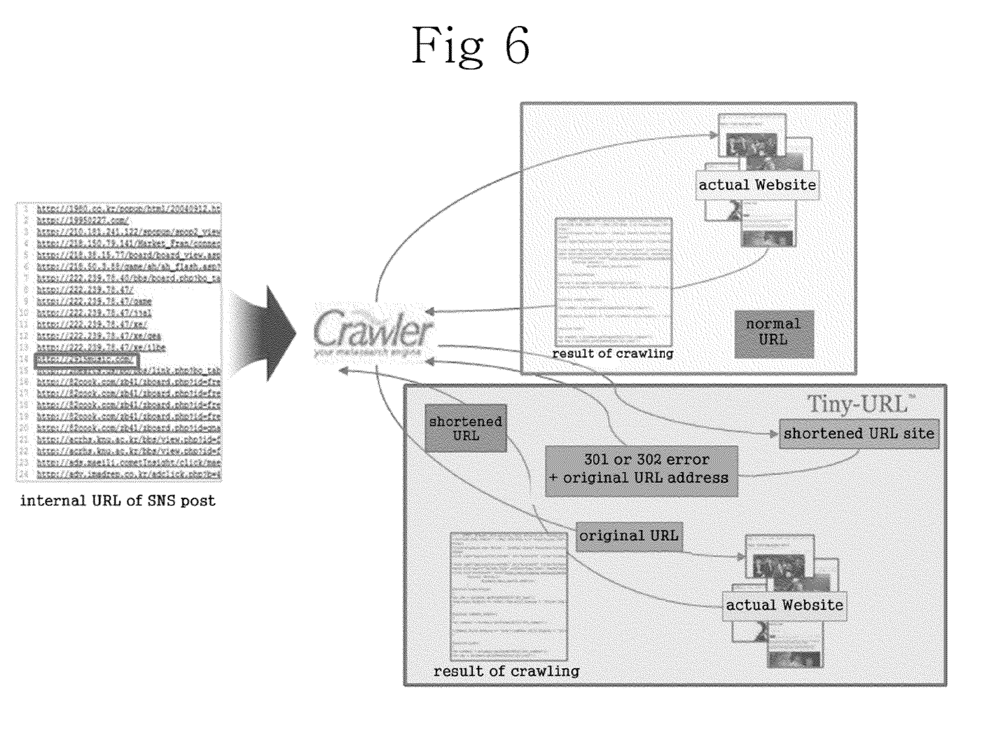

FIG. 6 is a diagram illustrating a process of processing a shortened URL according to the second embodiment of the present invention. Referring to FIG. 6, in the process of processing the shortened URL according to the second embodiment of the present invention, for example, an actual website is visited with URL information of ‘Crawler’ among URL information included in a first object, e.g., post, and when it is determined to be a normal URL, the URL may be crawled to generate an XML document form. However, when the URL information of ‘Crawler’ among URL information is determined to be a shortened URL, original URL information is obtained from a shortened URL site through the shortened URL information.

Thereafter, the actual website may be visited with the original URL information to obtain normal original URL information, and it is crawled to generate an XML document form. In this manner, although shortened URL information is included in post, the original URL information is obtained and utilized for collecting and checking a malicious code, or the like.

As set forth above, according to embodiments of the invention. URL information for a malicious code included in post (a bulletin script, a message, a note, or the like) exchanged in an SNS information can be effectively collected by using an account ID of account information and a password and utilized for detecting a malicious code in the SNS, whereby damage to users due to infection of a malicious code can be significantly reduced.

Also, according to embodiments of the invention, text content existing in SNS post (a bulletin script, a message, a note, or the like) and URL information (or shortened URL information) thereof are collected and utilized for detecting a malicious code, whereby damage to users due to infection of a malicious code can be further reduced.

In addition, since repeated URL information and original URL information are removed and a collection time thereof is recorded, URL information by account dealt in an SNS site can be conveniently managed and a security management can be secured.

Further, since a post check open API is used to obtain post, the open API can also be used for the purpose of removing a malicious code, beyond the existing limitation of program development.

While the present invention has been shown and described in connection with the embodiments, it will be apparent to those skilled in the art that modifications and variations can be made without departing from the spirit and scope of the invention as defined by the appended claims.

1. A social networking service (SNS) trap collection system comprising:
an SNS account collecting module configured to periodically check subscribed o registered account information of each SNS site, and XML-parse the checked account information to collect the same;
an account calling module configured to call a certain account which has logged in to the SNS site based on account ID/password information as the result of the XML parsing;
a post collecting module configured to collect post of the called account by using a post check open API;
a URL collecting module configured to store text content of each collected post and extract and collect URL information included in the text content; and
a URL storage module configured to store the collected URL information in the form of an XML document.

2. The system of claim 1, further comprising:
an original URL collecting module configured to access an original site which has generated a shortened URL to obtain original URL information from the original site, when the URL information is a shortened URL.

3. The system of claim 2, wherein the URL storage module stores the URL information and original URL information in the form of a BOARD tag or MSG tag in the XML document.

4. The system of claim 1, wherein the post collecting module collects the post through crawling.

5. The system of claim 4, further comprising:
a URL management module configured to cheek whether or not the URL information and the original URL information are repeated based on the stored XML document, remove the repeated URL information and original URL information, and record a collecting time.

6. A social networking service (SNS) uniform resource locator (URL) collection method comprising:
(a) periodically check subscribed account information of each SNS site to determine whether or not a check period, of the account information has lapsed;
(b) when the check period has not been lapsed according to the determination result. XML-parsing the checked account information and collecting the same;
(c) calling a certain account which has logged in to the SNS site based on account ID/password information as the result of XML-parsing;
(d) determining whether or not there is post initiated by the called account by using a post check open API;
(e) when there is post according to the determination result, collecting the post;
(f) storing text content of each collected post, and extracting and collecting URL information included in the text content; and
(g) storing the collected URL information in the forth of an XML document.

7. The method of claim 6, wherein (b) comprises: (h) when the check period has lapsed according to the determination result, comparing the number of accounts to be checked within the period and the number of already analyzed accounts and performing (c) when the number of analyzed accounts is greater,

8. The method of claim 6, further comprising:
(i) when the URL information is a shortened URL, accessing an original site which has generated the shortened URL and obtaining original URL information from the original site.

9. The method of claim 8, further comprising:
(j) checking whether or not the URL information and the original URL information are repeated based on the XML document, respectively, removing the repeated URL information and original URL information, and recording a collecting time.

10. The method of claim 8, wherein, in (f), the URL information and the original URL information are stored in the form of a BOARD tag or an MSG tag in the XML document.

11. The system of claim 2, wherein the post collecting module collects the post through crawling.

12. The system of claim 3, wherein the post collecting module collects the post through crawling.
